(19) United States
(12) Patent Application Publication
(10) Pub. No.: US 2006/0034354 A1
(43) Pub. Date: Feb. 16, 2006

(54) Apparatus, methods and computer program products for positioning system signal processing using parallel computational techniques

(76) Inventor: William O. Camp JR., Chapel Hill, NC (US)

Correspondence Address: Robert M. Meeks;Myers Bigel Sibley & Sajovec, Post Office Box 37428, Raleigh, NC, 27627, US

(21) Appl. No.: 10/919,154

(22) Filed: Aug. 16, 2004

(51) Int. Cl. H04B 1/707; H04L 27/06

(52) U.S. Cl. 375/150; 375/343

(57) ABSTRACT

A radio signal is processed to generate 1-bit signal values. The 1-bit signal values are bitwise logically combined (e.g., XORed) with a 1-bit quantized carrier demodulation template to produce demodulated 1-bit signal values. The demodulated 1-bit signal values are bitwise logically combined (e.g., XORed) with the positioning system modulation code to produce a plurality of 1-bit correlation values. The 1-bit correlation values are arithmetically combined (e.g., summed) to generate a correlation metric. The positioning system modulation code is detected responsive to the correlation metric. The 1-bit signal values may be are arranged into a signal value word that is bitwise logically combined with a carrier demodulation template word to produce a demodulated signal value word. The demodulated signal value word is bitwise logically combined with the positioning system modulation code word to produce a correlation value word. Bits in the correlation value word are arithmetically combined to generate the correlation metric. Such approaches can take advantage of highly parallel processing structures available in some DSP chips.

### BACKGROUND OF THE INVENTION

The present invention relates to signal processing, and more particularly, to apparatus, methods and computer program products for processing positioning system signals.

The Global Positioning System (GPS) is a space-based navigational communications system fielded by the United States government that uses satellites and associated ground-based components to provide positional information around the earth. Advantages of this navigational system over land-based systems include worldwide and continuous coverage, which may be highly accurate regardless of weather conditions. A similar system, the Global Orbiting Navigational Satellite System (GLONASS), is operated by the Russian Federation (the former Soviet Union), and another similar system, Galileo, will soon be deployed by the European Union and the European Space Agency.

In operation, GPS satellites orbit the earth and continually emit GPS radio signals. A GPS receiver, e.g., a portable device with a GPS processor, receives the radio signals from visible satellites and measures the time that the radio signal takes to travel from the GPS satellites to the GPS receiver antenna and, from this information, calculates a range for each acquired satellite, which may be used to determine terrestrial position of the receiver. Standalone GPS receivers are widely used by military forces, mariners, hikers, and surveyors. GPS capability may also be provided in mobile communications terminals (e.g., cellular handsets) to provide position location functionality that may be used, for example, for location based services (LBS).

Ephemeris information provided in the GPS satellite radio signal typically describes the satellite's orbit and velocity, which can be used to calculate the position of a GPS receiver. Generation of an accurate positional fix by a GPS receiver typically requires the acquisition of a set of navigational parameters from the navigational data signals from at least three GPS satellites.

An acquisition process for a GPS satellite signal may involve detection of a modulation code of the spread-spectrum GPS signal, so that it can be demodulated to obtain timing and/or satellite ephemeris information. Generally, the amount of searching required to detect the code can be reduced proportionate to the amount (or accuracy) of a priori timing and/or position information the GPS receiver possesses at the start of the search. For example, if the GPS receiver has a priori information of which GPS satellites are visible and information on the trajectories of these satellites, the receiver can reduce the number of satellites for which the receiver searches and the range of Doppler shifts and/or code phase shifts the receiver searches.

Many GPS receivers are programmed with almanac data, which coarsely describes the expected satellite positions for up to one year ahead. A GPS-enabled device, such as a mobile station, may be configured to receive assistance data that enables the device to roughly estimate its position with respect to the satellites of the GPS system. For example, local time and position estimates, satellite ephemeris and clock information, and visible satellite list (which varies with the location of the mobile station) may be transmitted to such a GPS-enabled device from terrestrially based infrastructure, such as a cellular network. Such assistance data can permit a GPS receiver to expedite the signal acquisition process.

A typical GPS-enabled device includes a radio processor that downconverts a radio signal received from an antenna to an intermediate frequency (IF) signal, which is then demodulated at each of a plurality of discrete IF frequencies corresponding to a range of possible frequency errors that may be attributable to Doppler shift due to relative movement of the device and the transmitting satellite, local oscillator frequency errors, and other sources. Each of the demodulated signals is then correlated with the satellite's assigned spreading code at each of a plurality of time shifts to generate correlation information that is used to determine the timing of the satellite's spread-spectrum signal. The receiver may then use this timing information to further demodulate the satellite data signal and determine its propagation time.

### SUMMARY OF THE INVENTION

In some embodiments of the present invention, methods of searching for a positioning system modulation code in a radio signal include processing the radio signal to generate 1-bit signal values, bitwise logically combining (e.g., XORing) the 1-bit signal values with a 1-bit quantized carrier demodulation template to produce demodulated 1-bit signal values, bitwise logically combining (e.g., XORing) demodulated 1-bit signal values with the positioning system modulation code to produce a plurality of 1-bit correlation values, and arithmetically combining (e.g., summing) the 1-bit correlation values to generate a correlation metric. The positioning system modulation code is detected responsive to the correlation metric.

Such approaches can take advantage of highly parallel processing structures available, for example, in some DSP chips. In further embodiments of the present invention, for example, the 1-bit signal values are arranged into a signal value word, and bitwise logically combining the 1-bit signal values with a 1-bit quantized carrier demodulation template to produce demodulated 1-bit signal values includes bitwise logically combining the signal value word with a carrier demodulation template word to produce a demodulated signal value word. Bitwise logically combining the demodulated 1-bit signal values with the positioning system modulation code to produce a plurality of 1-bit correlation values includes bitwise logically combining the demodulated signal value word with a positioning system modulation code word to produce a correlation value word. Arithmetically combining the 1-bit correlation values to generate a correlation metric includes arithmetically combining bits in the correlation value word to generate the correlation metric.

According to additional embodiments of the present invention, the respective acts of logically combining the signal value word with a carrier demodulation template word to produce a demodulated signal value word, logically combining the demodulated signal value word with the positioning system modulation code word, and arithmetically combining bits in the correlation value word to generate the correlation metric are performed in respective single processor cycles using parallel computing operations available, for example, in some DSP chips.

In still further embodiments of the present invention, bitwise logically combining the 1-bit signal values with a 1-bit quantized carrier demodulation template to produce demodulated 1-bit signal values includes bitwise exclusive-ORing (XORing) the 1-bit signal values with a 1-bit quantized carrier demodulation template to produce the demodulated 1-bit signal values. Bitwise logically combining the demodulated 1-bit signal values with the positioning system modulation code to produce a plurality of 1-bit correlation values includes bitwise exclusive-ORing the demodulated 1-bit signal values with the positioning system modulation code to produce the plurality of 1-bit correlation values.

According to some embodiments, bitwise logically combining the 1-bit signal values with a 1-bit quantized carrier demodulation template to produce demodulated 1-bit signal values is preceded by shifting the 1-bit signal values or the 1-bit quantized carrier demodulation template based on a carrier timing hypothesis, and arithmetically combining the 1-bit correlation values to generate a correlation metric includes arithmetically combining the 1-bit correlation values to generate a correlation metric for the carrier timing hypothesis. In still further embodiments, bitwise logically combining the demodulated 1-bit signal values with the positioning system modulation code to produce a plurality of 1-bit correlation values is preceded by shifting the demodulated 1-bit signal values and or the positioning system modulation code based on the positioning system modulation code timing hypothesis, and arithmetically combining the 1-bit correlation values to generate a correlation metric includes arithmetically combining the 1-bit correlation values to generate a correlation metric for the positioning system modulation code timing hypothesis.

In some embodiments, bitwise logically combining the 1-bit signal values with a 1-bit quantized carrier demodulation template to produce demodulated 1-bit signal values includes bitwise logically combining 1-bit signal values with respective I and Q templates to generate respective 1-bit I and Q signal values and bitwise logically combining the 1-bit I and Q signal values with respective 1-bit quantized I and Q carrier demodulation templates to produce respective I and Q demodulated 1-bit signal values. Bitwise logically combining the demodulated 1-bit signal values with the positioning system modulation code to produce a plurality of 1-bit correlation values includes bitwise logically combining the demodulated 1-bit I and Q signal values with the positioning system modulation code to produce respective pluralities of 1-bit I and Q correlation values. Arithmetically combining the 1-bit correlation values to generate a correlation metric includes arithmetically combining the respective pluralities of I and Q 1-bit correlation values to generate respective I and Q correlation metrics. Detecting the positioning system modulation code responsive to the correlation metric includes detecting the positioning system modulation code responsive to the I and Q correlation metrics.

In other embodiments of the present invention, the acts of bitwise logically combining the 1-bit signal values with a 1-bit quantized carrier demodulation template to produce demodulated 1-bit signal values, bitwise logically combining the demodulated 1-bit signal values with the positioning system modulation code to produce a plurality of 1-bit correlation values, and arithmetically combining the 1-bit correlation values to generate a correlation metric are performed for each of a plurality of combinations of carrier timing and positioning system modulation code timing hypotheses to generate a plurality of correlation metrics. Detecting the positioning system modulation code responsive to the correlation metric includes detecting the positioning system modulation code responsive to the plurality of correlation metrics.

According to further embodiments of the present invention, a positioning system receiver includes a radio processor configured to receive a radio signal and to produce quantized 1-bit signal values therefrom. The receiver further includes a signal processor configured to bitwise logically combine the 1-bit signal values with a 1-bit quantized carrier demodulation template to produce demodulated 1-bit signal values, to bitwise logically combine the demodulated 1-bit signal values with the positioning system modulation code to produce a plurality of 1-bit correlation values, to arithmetically combine the 1-bit correlation values to generate a correlation metric, and to detect the positioning system modulation code responsive to the correlation metric. The signal processor may be operative to arrange the 1-bit signal values into a signal value word, to logically combine the signal value word with a carrier demodulation template word to produce a demodulated signal value word, to logically combine the demodulated signal value word with the positioning system modulation code word to produce a correlation value word, and to arithmetically combine bits in the correlation value word to generate the correlation metric. More particularly, the signal processor may be operative to logically combine the signal value word with a carrier demodulation template word to produce a demodulated signal value word, to logically combine the demodulated signal value word with the positioning system modulation code word, and to arithmetically combine bits in the correlation value word to generate the correlation metric in respective single processor cycles.

According to other aspects of the present invention, a computer program product for searching for a positioning system modulation code in 1-bit signal values corresponding to a radio signal is provided. The computer program product includes computer program code embodied in a computer readable storage medium, the computer program code including code configured to bitwise logically combine the 1-bit signal values with a 1-bit quantized carrier demodulation template to produce demodulated 1-bit signal values, code configured to bitwise logically combine the demodulated 1-bit signal values with the positioning system modulation code to produce a plurality of 1-bit correlation values, code configured to arithmetically combine the 1-bit correlation values to generate a correlation metric, and code configured to detect the positioning system modulation code responsive to the correlation metric.

In yet other embodiments of the present invention, a mobile terminal includes a radio processor configured to receive a radio signal and to produce quantized 1-bit signal values therefrom. The terminal also includes a digital signal processor (DSP) chip, for example, a DSP chip used for baseband processing and other tasks associated with mobile communications, configured to bitwise logically combine the 1-bit signal values with a 1-bit quantized carrier demodulation template to produce demodulated 1-bit signal values, to bitwise logically combine the demodulated 1-bit signal values with the positioning system modulation code to produce a plurality of 1-bit correlation values, to arithmetically combine the 1-bit correlation values to generate a correlation metric, and to detect a positional system positioning system modulation code responsive to the correlation metric. The DSP chip may be configured to arrange the 1-bit signal values into a signal value word, to logically combine the signal value word with a carrier demodulation template word to produce a demodulated signal value word, to logically combine the demodulated signal value word with the positioning system modulation code word to produce a correlation value word, and to arithmetically combine bits in the correlation value word to generate the correlation metric. The DSP chip may be configured to logically combine the signal value word with a carrier demodulation template word to produce a demodulated signal value word, to logically combine the demodulated signal value word with the positioning system modulation code word, and to arithmetically combine bits in the correlation value word to generate the correlation metric in respective single processor cycles.

### BRIEF DESCRIPTION OF THE DRAWINGS

FIG. 1 is a schematic diagram illustrating a GPS receiver according to some embodiments of the present invention.

FIGS. 2 and 3 are flowcharts illustrating exemplary operations according to further embodiments of the present invention.

FIG. 4 is a schematic diagram illustrating a GPS-enabled mobile terminal according to some embodiments of the present invention.

### DETAILED DESCRIPTION OF EXEMPLARY EMBODIMENTS

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the terms “comprising”, “comprises”, “includes”and “including” are open-ended, i.e., refer to one or more stated elements, acts and/or functions without precluding one or more unstated elements, acts and/or functions. It will also be understood that the term “and/or” as used herein refers to and encompasses any and all possible combinations of one or more of the associated listed items. It will be further understood that when a transfer, communication, or other interaction is described as occurring “between” elements, such transfer, communication or other interaction may be unidirectional and/or bidirectional.

The present invention is described below with reference to block diagrams and/or operational illustrations of methods and apparatus according to various embodiments of the invention. It will be understood that each block of the block diagrams and/or operational illustrations, and combinations of blocks in the block diagrams and/or operational illustrations, can be implemented by analog and/or digital hardware and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some alternate implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

According to some embodiments of the present invention, an apparatus may include circuitry configured to provide operations described herein. Such apparatus may include any of a number of types of devices, including, but not limited to: navigational devices; mobile terminals, such as cellular handsets; computers and peripherals that include a communications interface; personal communication terminals that may combine a cellular wireless terminal with data processing, facsimile and data communications capabilities; and personal data assistants (PDA) that can include a wireless transceiver, pager, Internet/intranet access, local area network interface, wide area network interface, Web browser, organizer, and/or calendar.

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

Some embodiments of the present invention arise from a realization that GPS signal processing, such as searching carrier and/or positioning system modulation code timing hypotheses, may be rendered faster and/or more efficient by using highly parallel computing architectures, such as those found in some digital signal processors (DSPs). For example, some DSP chips, such as the TI TMS320C55x family of DSP chips, have the ability to perform bitwise logical combinations (e.g., AND, XOR, etc.) of words (registers) in a single cycle and to generate an arithmetic combination (e.g., sums) of bits within a word in a single cycle. According to some embodiments of the present invention, GPS signal acquisition procedures can take advantage of such capabilities by quantizing signal values to 1-bit values and combining these 1-bit values into registers such that search operations, such as I-Q sample separation, carrier demodulation, and PN code correlation, may be performed using the above-described parallel processing operations. Such approaches can, for example, allow a GPS capability to be integrated in a mobile communications terminal while using existing signal processing resources, e.g., a DSP that is also used for signal processing for mobile communications purposes, and can also provide improved performance, e.g., improved time to fix and/or improved signal detection, by accelerating search operations.

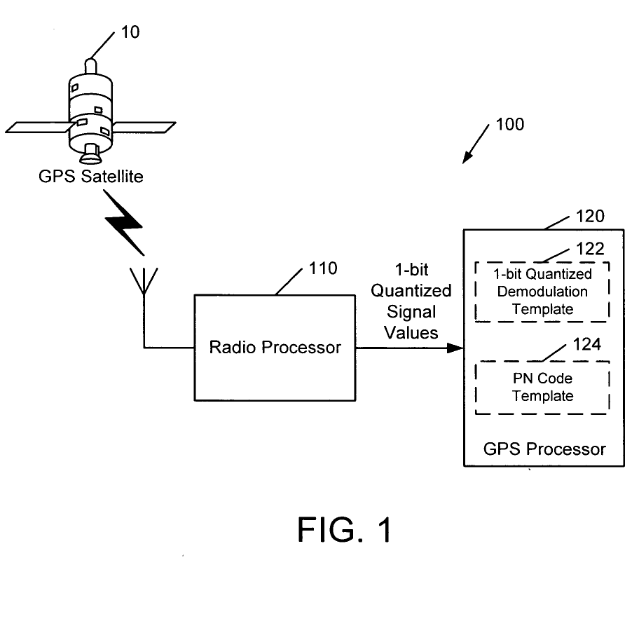

FIG. 1 illustrates a GPS apparatus 100 according to some embodiments of the present invention. The apparatus 100 includes a radio processor 110 that is configured to receive a radio signal including a GPS signal transmitted by a GPS satellite 10. The radio processor 110 is operative to produce 1-bit quantized signal values from the received radio signal, e.g., by downconversion from radio frequency (RF) to an intermediate frequency (IF), as well as sampling and quantization operations. The apparatus 100 also includes a GPS processor 120 that receives the 1-bit samples and performs bitwise logical operations on the quantized signal values using a 1-bit quantized carrier demodulation template 122 and a PN code template 124. Using 1-bit quantization can allow for use of, for example, a highly parallel computing architecture to efficiently compute signal correlation metrics for GPS signal searching processes, as will now be described in detail.

A copending U.S. patent application Ser. No. ______, (Attorney Docket No. U040115/9314-85), entitled Apparatus, Methods and Computer Program Products for Spread-Spectrum Signal Acquisition Using Common Modulation Templates, filed concurrently herewith and incorporated by reference herein in its entirety, describes techniques by which signal values representing a carrier-modulated signal can be carrier demodulated and correlated with a target modulation, such as a GPS PN code, for multiple combinations of carrier timing and positioning system modulation code timing hypotheses. In some embodiments described therein, for example, the signal samples are shifted according to a relationship between the carrier timing hypotheses and a reference carrier timing. A common demodulation template, associated with the reference carrier timing, is applied to the shifted signal values to achieve carrier demodulation. The resulting demodulated signal values may then be shifted according to positioning system modulation code timing hypothesis to align with a common code template for generating a correlation metric for the particular combination of carrier and positioning system modulation code timing hypotheses. In alternative embodiments, shifting may be applied to carrier demodulation and/or code templates for different carrier timing and/or positioning system modulation code timing hypotheses. Each of these techniques may be used with the parallel computing techniques according to various embodiments of the present invention described herein.

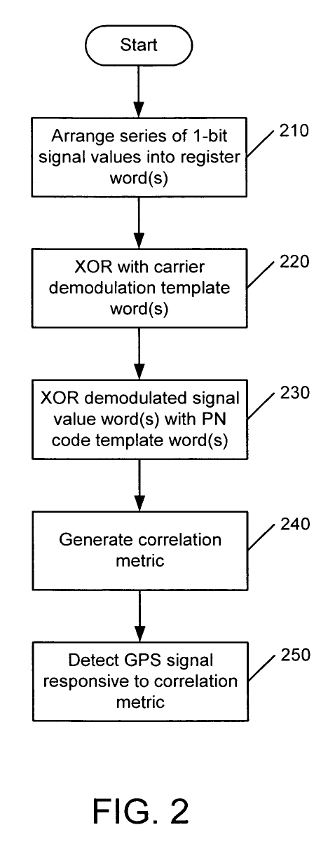

FIG. 2 illustrates exemplary GPS signal search operations that combine techniques of the aforementioned U.S. patent application Ser. No. ______, (Attorney Docket No. U040115/9314-85) with parallel computation operations described herein according to some embodiments of the present invention. A series of 1-bit signal values corresponding to a received radio signal are arranged into one or more words in a digital signal processor (block 210). The one or more signal value words are then bitwise logically combined (e.g., in a bitwise XOR operation) with one or more carrier demodulation template words (block 220). The resulting demodulated signal value word(s) is then bitwise logically combined (e.g., in a bitwise XOR operation) with a PN code template word (block 230). A correlation metric may be determined from the resulting word(s) (block 240). The correlation metric may represent a measure of the degree of correlation of the signal value stream with the particular demodulation template and PN code template. For example, as described in the aforementioned U.S. patent application Ser. No. ______, (Attorney Docket No. U040115/9314-85), an L1 correlation metric may be determined directly from the result of the bitwise logical combination with the PN code template word and/or an L2 metric may be determined by separating the result of the bitwise logical combination with the PN code template word using 1-bit quantized I and Q templates, generating correlation sums for each of the resulting I and Q components, and determining a square root of the sum of the squares of the I and Q sums.

As shown, a GPS signal may be detected responsive to the correlation metric by, for example, comparing the correlation metric to similarly generated correlation metrics for other carrier demodulation templates and other PN code templates (block 250). Implemented in a DSP having a one-cycle logical combination and one-cycle bit summation capability along the lines described above, the respective bitwise logical combination (blocks 220, 230) and summation (block 240) operations may, for example, be performed in respective single cycles.

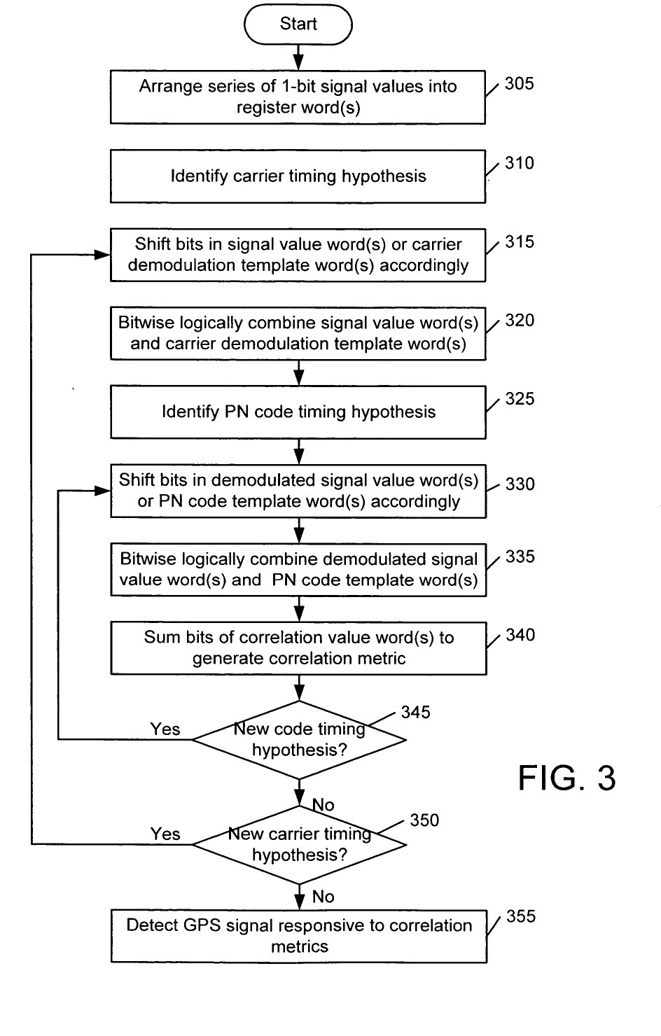

FIG. 3 illustrates exemplary recursive signal search techniques according to further embodiments of the present invention. A series of 1-bit signal values are arranged into one or more signal value words (block 305). A carrier timing hypothesis is identified (block 310), and bits in the signal value word or in one or more carrier demodulation template words are shifted accordingly (block 315). A bitwise logical combination (e.g., XOR) of the signal value word(s) and the carrier demodulation template word(s) is then performed to generate one or more demodulated signal value words (block 320). This demodulation operation may include multiple template applications, e.g., application of I and Q templates to generate I and Q signal value words and application of demodulation template words to the I and Q signal value words to produce I and Q demodulate signal value words. A PN code timing hypothesis is then identified (block 325) and bits in the demodulated signal value word(s) or a PN code template word(s) shifted accordingly (block 330). A bitwise logical combination (e.g., XOR) of the demodulate signal value word(s) and the PN code template word(s) is performed to generate one or more correlation value words (block 335). The bits of the correlation value word(s) are summed to generate a correlation metric (block 340).

If an additional code timing hypothesis is to be evaluated (block 345), the PN code-related shifting (block 330), logical combining (block 335), and summation (block 340) operations are repeated to generate a correlation metric for the additional code timing hypothesis. Upon determination of correlation metrics for all the code timing hypotheses for a given carrier timing hypotheses, additional correlation metrics may be generated for other combinations of carrier hypotheses and code timing hypotheses (blocks 350, 315-345). A GPS signal is detected responsive to the correlation metrics, e.g., by identifying a peak correlation (block 355). As with the operations described with reference to FIG. 2, the logical combination and summation operations of FIG. 3 may take advantage of special computing architectures that can accomplish such operations in relatively small numbers of computing cycles.

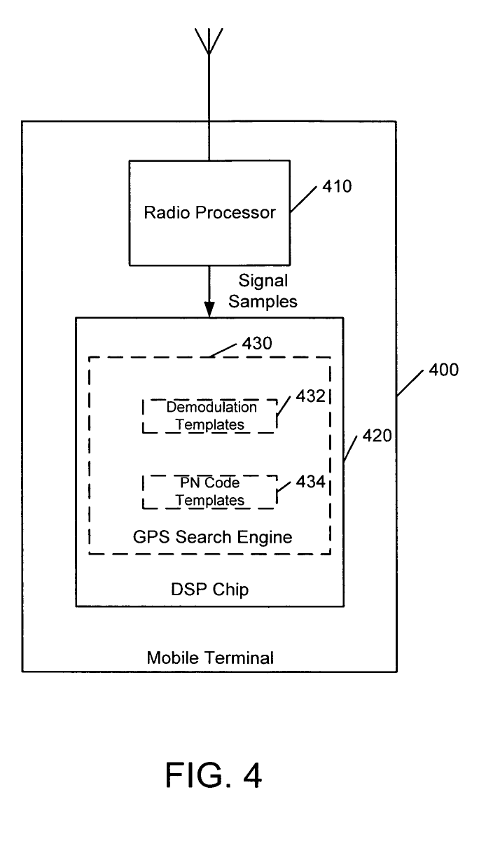

FIG. 4 illustrates a mobile terminal 400 configured to implement streamlined signal processing operations along the lines described above according to further embodiments of the present invention. The terminal 400 includes a radio processor 410 that is configured to receive radio signals and to generate signal (e.g. IF signal) samples therefrom. The terminal 400 further includes a digital signal processor (DSP) chip 420 configured by, for example, loading of appropriately configured program code, to provide a GPS search engine 430. The GPS search engine 430 is operative to process the signal samples produced by the radio processor 410 using single-bit streamlined correlation generation operations using carrier demodulation templates 432 and PN code templates 434 along the lines discussed above. The DSP 420 chip may be operative to provide single-cycle logical combination and arithmetic operations as described above, and the GPS search engine 430 may be configured to utilize such operations in generating correlation metrics. The DSP 420 chip may be further configured to provide other operations of the mobile terminal 400, such as baseband, audio processing, or other operations associated with mobile communications of the mobile terminal 400.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed:

1. A method of searching for a positioning system modulation code in a radio signal, the method comprising:
processing the radio signal to generate 1-bit signal values;
bitwise logically combining the 1-bit signal values with a 1-bit quantized carrier demodulation template to produce demodulated 1-bit signal values;
bitwise logically combining the demodulated 1-bit signal values with the positioning system modulation code to produce a plurality of 1-bit correlation values;
arithmetically combining the 1-bit correlation values to generate a correlation metric; and
detecting the positioning system modulation code responsive to the correlation metric.

2. A method according to claim 1:
wherein bitwise logically combining the 1-bit signal values with a 1-bit quantized carrier demodulation template to produce demodulated 1-bit signal values is preceded by arranging the 1-bit signal values into a signal value word;
wherein bitwise logically combining the 1-bit signal values with a 1-bit quantized carrier demodulation template to produce demodulated 1-bit signal values comprises bitwise logically combining the signal value word with a carrier demodulation template word to produce a demodulated signal value word;
wherein bitwise logically combining the demodulated 1-bit signal values with the positioning system modulation code to produce a plurality of 1-bit correlation values comprises bitwise logically combining the demodulated signal value word with a positioning system modulation code word to produce a correlation value word; and
wherein arithmetically combining the 1-bit correlation values to generate a correlation metric comprises arithmetically combining bits in the correlation value word to generate the correlation metric.

3. A method according to claim 2, wherein the respective acts of logically combining the signal value word with a carrier demodulation template word to produce a demodulated signal value word, logically combining the demodulated signal value word with the positioning system modulation code word, and arithmetically combining bits in the correlation value word to generate the correlation metric are performed in respective single processor cycles.

4. A method according to claim 3, performed in a wireless mobile communications terminal.

5. A method according to claim 1:
wherein bitwise logically combining the 1-bit signal values with a 1-bit quantized carrier demodulation template to produce demodulated 1-bit signal values comprises bitwise exclusive-ORing the 1-bit signal values with a 1-bit quantized carrier demodulation template to produce the demodulated 1-bit signal values; and
wherein bitwise logically combining the demodulated 1-bit signal values with the positioning system modulation code to produce a plurality of 1-bit correlation values comprises bitwise exclusive-ORing the demodulated 1-bit signal values with the positioning system modulation code to produce the plurality of 1-bit correlation values.

6. A method according to claim 1:
wherein bitwise logically combining the 1-bit signal values with a 1-bit quantized carrier demodulation template to produce demodulated 1-bit signal values is preceded by shifting the 1-bit signal values or the 1-bit quantized carrier demodulation template based on a carrier timing hypothesis; and
wherein arithmetically combining the 1-bit correlation values to generate a correlation metric comprises arithmetically combining the 1-bit correlation values to generate a correlation metric for the carrier timing hypothesis.

7. A method according to claim 1:
wherein bitwise logically combining the demodulated 1-bit signal values with the positioning system modulation code to produce a plurality of 1-bit correlation values is preceded by shifting the demodulated 1-bit signal values and or the positioning system modulation code based on a positioning system modulation code timing hypothesis; and
wherein arithmetically combining the 1-bit correlation values to generated a correlation metric comprises arithmetically combining the 1-bit correlation values to generate a correlation metric for the positioning system modulation code timing hypothesis.

8. A method according to claim 1:
wherein bitwise logically combining the 1-bit signal values with a 1-bit quantized carrier demodulation template to produce demodulated 1-bit signal values comprises:
bitwise logically combining 1-bit signal values with respective I and Q templates to generate respective 1-bit I and Q signal values; and
bitwise logically combining the 1-bit I and Q signal values with respective 1-bit quantized I and Q carrier demodulation templates to produce respective I and Q demodulated 1-bit signal values;
wherein bitwise logically combining the demodulated 1-bit signal values with the positioning system modulation code to produce a plurality of 1-bit correlation values comprises bitwise logically combining the demodulated 1-bit I and Q signal values with the positioning system modulation code to produce respective pluralities of 1-bit I and Q correlation values;
wherein arithmetically combining the 1-bit correlation values to generate a correlation metric comprises arithmetically combining the respective pluralities of I and Q 1-bit correlation values to generate respective I and Q correlation metrics; and
wherein detecting the positioning system modulation code responsive to the correlation metric comprises detecting the positioning system modulation code responsive to the I and Q correlation metrics.

9. A method according to claim 1, wherein the acts of bitwise logically combining the 1-bit signal values with a 1-bit quantized carrier demodulation template to produce demodulated 1-bit signal values, bitwise logically combining the demodulated 1-bit signal values with the positioning system modulation code to produce a plurality of 1-bit correlation values, and arithmetically combining the 1-bit correlation values to generate a correlation metric are performed for a plurality of combinations of carrier timing and positioning system modulation code timing hypotheses to generate a plurality of correlation metrics, and wherein detecting the positioning system modulation code responsive to the correlation metric comprises detecting the positioning system modulation code responsive to the plurality correlation metrics.

10. A positioning system receiver, comprising:
a radio processor configured to receive a radio signal and to produce quantized 1-bit signal values therefrom; and
a signal processor configured to bitwise logically combine the 1-bit signal values with a 1-bit quantized carrier demodulation template to produce demodulated 1-bit signal values, to bitwise logically combine the demodulated 1-bit signal values with the positioning system modulation code to produce a plurality of 1-bit correlation values, to arithmetically combine the 1-bit correlation values to generate a correlation metric, and to detect the positioning system modulation code responsive to the correlation metric.

11. A receiver according to claim 10, wherein the signal processor is operative to arrange the 1-bit signal values into a signal value word, to logically combine the signal value word with a carrier demodulation template word to produce a demodulated signal value word, to logically combine the demodulated signal value word with the positioning system modulation code word to produce a correlation value word, and to arithmetically combine bits in the correlation value word to generate the correlation metric.

12. A receiver according to claim 11, wherein the signal processor is operative to logically combine the signal value word with a carrier demodulation template word to produce a demodulated signal value word, to logically combine the demodulated signal value word with the positioning system modulation code word, and to arithmetically combine bits in the correlation value word to generate the correlation metric in respective single processor cycles.

13. A receiver according to claim 10, wherein the signal processor is operative to bitwise exclusive-OR the 1-bit signal values with a 1-bit quantized carrier demodulation template to produce the demodulated 1-bit signal values and to bitwise exclusive-OR the demodulated 1-bit signal values with the positioning system modulation code to produce the plurality of 1-bit correlation values.

14. A receiver according to claim 10, wherein the signal processor is operative to shift the 1-bit signal values or the 1-bit quantized carrier demodulation template based on a carrier timing hypothesis and to arithmetically combine the 1-bit correlation values to generate a correlation metric for the carrier timing hypothesis.

15. A receiver according to claim 10, wherein the signal processor is operative to shift the demodulated 1-bit signal values and or the positioning system modulation code based on the positioning system modulation code timing hypothesis and to arithmetically combine the 1-bit correlation values to generate a correlation metric for the positioning system modulation code timing hypothesis.

16. A receiver according to claim 10, wherein the signal processor is operative to bitwise logically combine 1-bit signal values with respective I and Q templates to generate respective 1-bit I and Q signal values, to bitwise logically combine the 1-bit I and Q signal values with respective 1-bit quantized I and Q carrier demodulation templates to produce respective I and Q demodulated 1-bit signal values, to bitwise logically combine the demodulated 1-bit I and Q signal values with the positioning system modulation code to produce respective pluralities of 1-bit I and Q correlation values, to arithmetically combine the respective pluralities of I and Q 1-bit correlation values to generate respective I and Q correlation metrics, and to detect the positioning system modulation code responsive to the I and Q correlation metrics.

17. A receiver according to claim 10, wherein the signal processor is operative, for each of a plurality of combinations of carrier timing and positioning system modulation code timing hypotheses, to bitwise logically combine the 1-bit signal values with a 1-bit quantized carrier demodulation template to produce demodulated 1-bit signal values, to bitwise logically combine the demodulated 1-bit signal values with the positioning system modulation code to produce a plurality of 1-bit correlation values, and to arithmetically combine the 1-bit correlation values to generate a correlation metric to generate a plurality of correlation metrics, and to detect the positioning system modulation code responsive to the plurality of correlation metrics.

18. A computer program product for searching for a positioning system positioning system modulation code in 1-bit signal values corresponding to a radio signal, the computer program product comprising computer program code embodied in a computer readable storage medium, the computer program code comprising:
code configured to bitwise logically combine the 1-bit signal values with a 1-bit quantized carrier demodulation template to produce demodulated 1-bit signal values;
code configured to bitwise logically combine the demodulated 1-bit signal values with the positioning system modulation code to produce a plurality of 1-bit correlation values;
code configured to arithmetically combine the 1-bit correlation values to generate a correlation metric; and
code configured to detect the positioning system modulation code responsive to the correlation metric.

19. A computer program product according to claim 1, wherein the computer program code further comprises code configured to arranging the 1-bit signal values into a signal value word, wherein the code configured to bitwise logically combine the 1-bit signal values with a 1-bit quantized carrier demodulation template to produce demodulated 1-bit signal values comprises code configured to logically combine the signal value word with a carrier demodulation template word to produce a demodulated signal value word, wherein the code configured to bitwise logically combine the demodulated 1-bit signal values with the positioning system modulation code to produce a plurality of 1-bit correlation values comprises code configured to logically combine the demodulated signal value word with the positioning system modulation code word to produce a correlation value word, and wherein the code configured to arithmetically combine the 1-bit correlation values to generate a correlation metric comprises code configured to arithmetically combine bits in the correlation value word to generate the correlation metric.

20. A mobile terminal, comprising:
a radio processor configured to receive a radio signal and to produce quantized 1-bit signal values therefrom; and
a digital signal processor (DSP) chip configured to bitwise logically combine the 1-bit signal values with a 1-bit quantized carrier demodulation template to produce demodulated 1-bit signal values, to bitwise logically combine the demodulated 1-bit signal values with the positioning system modulation code to produce a plurality of 1-bit correlation values, to arithmetically combine the 1-bit correlation values to generate a correlation metric, and to detect a positioning system positioning system modulation code responsive to the correlation metric.

21. A mobile terminal according to claim 20, wherein the DSP chip is configured to arrange the 1-bit signal values into a signal value word, to logically combine the signal value word with a carrier demodulation template word to produce a demodulated signal value word, to logically combine the demodulated signal value word with the positioning system modulation code word to produce a correlation value word, and to arithmetically combine bits in the correlation value word to generate the correlation metric.

22. A mobile terminal according to claim 21, wherein the DSP chip is configured to logically combine the signal value word with a carrier demodulation template word to produce a demodulated signal value word, to logically combine the demodulated signal value word with the positioning system modulation code word, and to arithmetically combine bits in the correlation value word to generate the correlation metric in respective single processor cycles.
